(19) United States
(12) Patent Application Publication
(10) Pub. No.: US 2002/0083325 A1
(43) Pub. Date: Jun. 27, 2002

(54) Updating security schemes for remote client access

(76) Inventors: Bharat Mediratta, Menlo Park, CA (US); Thomas A. Berson, Palo Alto, CA (US); Stephen M. Rudy, Palo Alto, CA (US)

Correspondence Address: William J. Harmon, III, Vierra Magen Marcus Harmon & DeNiro, LLP, 685 Market Street, Suite 540, San Francisco, CA, 94105-4206, US

(21) Appl. No.: 10/003,027

(22) Filed: Nov. 2, 2001

Related U.S. Application Data
(60) Provisional application No. 60/245,949, filed on Nov. 3, 2000.
(60) Provisional application No. 60/246,623, filed on Nov. 7, 2000.

(51) Int. Cl. H04K 1/00

(52) U.S. Cl. 713/182

(57) ABSTRACT

An intermediate system provides remote clients with access to a primary system. The intermediate system creates and stores a log-in record for each client. The log-in record contains an encrypted primary system client identifier (PSCI) and a security scheme identifier (Security ID). The PSCI contains authentication information for verifying a client's right to access the primary system. The Security ID identifies the security scheme employed to secure information for a client's log-in process. The intermediate system initially verifies a client's access rights using the security scheme identified by the Security ID and data provided by the client. Next, the intermediate system sends the PSCI to the client's primary system, which uses the PSCI to verify the client's access rights. When necessary, a security scheme update modifies values in the client log-in record. The update modifies values that depend on log-in data provided by the client, including modifications to the encrypted PSCI. Using the client's log-in data eliminates the need to separately request data from the client for security scheme updates.

### CLAIM OF PRIORITY

The present application claims priority to the following U.S. Provisional Patent Applications:

U.S. Provisional Patent Application Serial No. 60/245,949, entitled “Methods of Secure Authentication of Users Via Intermediate Parties,” filed on Nov. 3, 2000; and

U.S. Provisional Patent Application Serial No. 60/246,623, entitled “Techniques for Encrypting Passwords,” filed on Nov. 7, 2000.

### CROSS-REFERENCE TO RELATED APPLICATION

The present application is related to the following application:

Secure Authentication of Users Via Intermediate Parties, by Thomas A. Berson and Stephen M. Rudy, Attorney Docket No. FUSN1-01300US1, filed Nov. 2, 2001.

The above-identified application is incorporated herein by reference.

### BACKGROUND OF THE INVENTION

1. Field of the Invention

The present invention is directed to the field of securing computer communications.

2. Description of the Related Art

People frequently access data maintained on primary computer systems, such as file servers, from remote client computing devices. Examples of remote client devices include laptop computers, cellular telephones, personal digital assistants (“PDAs”), and personal computers. Intermediate entities facilitate clients' remote access to primary system data. In some instances, intermediate entities provide services for clients that use primary system data. For example, an intermediate entity may provide a data synchronization service—enabling a person to synchronize common data records maintained on both a primary system and a client computing device. Examples of common data records include calendars and address books, which are stored on a primary computer and a PDA.

In providing remote access services, intermediate entities strive to ensure that data on primary systems is neither stolen nor destroyed. Authenticating clients' rights to access primary system data plays a critical role. Intermediate entities may regulate data access by maintaining a database of user authentication information, such as passwords. When a client attempts to remotely access a primary system through an intermediate entity, the client submits authentication information. The intermediate entity then queries the database of authentication information to verify the client's access rights.

However, maintaining a database of client authentication information at an intermediate entity presents a security drawback. Computer hackers can illegitimately obtain the authentication information from the intermediate entity's computer system. The hackers can then use client passwords to modify, steal or destroy data from primary systems.

### SUMMARY OF THE INVENTION

Embodiments of the present invention enable computer systems, such as intermediate entities, to seamlessly employ and upgrade security schemes to safeguard client authentication information.

Clients log into a primary system, such as a file server, through an intermediate entity's computer system, referred to as an intermediate system. The intermediate system creates and stores a log-in record for each client Each log-in record contains a security identifier (“Security ID”) and an encrypted version of a primary system client identifier (“PSCI”). The PSCI contains authentication information for verifying a client's right to access a primary system. Storing an encrypted version of the PSCI on the intermediate system significantly impedes a computer hacker's ability to steal client authentication information. The Security ID identifies a security scheme currently employed by the intermediate system, including the encryption techniques used to create the encrypted PSCI.

In an initial phase of the log-in process, the intermediate system authenticates a client's right to access the intermediate system. In some implementations, the intermediate system log-in record for each client includes a hashed password. During the log-in process, the intermediate system hashes a password provided by the client and determines whether it matches the hashed version of the password in the client's log-in record. The Security ID field in the client's log-in record specifies the hash function employed for the client. Storing the hashed password relieves the intermediate system from storing the client's password-making the client's password more secure from computer hackers.

After a client's right to access the intermediate system is established, the client's primary system authenticates the client. The intermediate system sends the client's PSCI value to the client's primary system. The intermediate system obtains the PSCI value by decrypting the encrypted version of the PSCI in the client's log-in record. The intermediate system employs a decryption function specified in the client's Security ID field. The primary system uses the PSCI value to verify the client's right to access primary system data. In one embodiment, the PSCI value includes a client password that verifies the client's identity to the primary system.

Once the client is authenticated, the intermediate system determines whether the Security ID in the client's log-in record corresponds to the desired security scheme for the client. The desired security system is the one to be employed the next time the client attempts to log into the intermediate system. If the intermediate system's desired security scheme is different than the current security scheme, the system modifies the client's log-in record Security ID to identify the desired scheme. A security scheme for a client may change for several reasons, including an upgrade from the current security scheme.

In addition to updating the Security ID, the intermediate system implements any further security scheme modifications that may be required. For example, the desired security scheme may call for new hashing and encryption techniques to be employed for generating the hashed password and encrypted PSCI. In this case, the intermediate system generates a new hashed password and encrypted PSCI value using the hashing and encryption techniques from the new desired security scheme. The intermediate system then stores these values in the client's log-in record. Automatically updating the system's security scheme as part of the authentication process makes the update seamless to the client.

Aspects of the present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 illustrates a system for providing remote client access to a primary system through an intermediate system in accordance with the present invention.

FIG. 2 depicts a process for providing remote client access to a primary system and security scheme updates in accordance with the present invention.

FIG. 3 illustrates a process for an intermediate system to authenticate a client's access rights in the embodiment of the present invention shown in FIG. 2.

FIG. 4 illustrates a process for an intermediate system to obtain and send primary system authentication data in the embodiment of the present invention shown in FIG. 2.

FIG. 5 shows a process for a primary system to authenticate a client's access rights in the embodiment of the invention shown in FIG. 3.

FIG. 6 shows a process for modifying a client log-in record to reflect a security scheme update in one embodiment of the present invention.

FIG. 7 depicts a process for providing remote client access to a primary system and security scheme updates in an alternate embodiment of the present invention.

FIG. 8 illustrates a process for an intermediate system to authenticate a client's access rights in the embodiment of the present invention shown in FIG. 7.

FIG. 9 illustrates a process for a primary system to authenticate a client's access rights in the embodiment of the invention shown in FIG. 8.

FIG. 10 shows a process for modifying a client log-in record to reflect a security scheme update in one embodiment of the present invention.

FIG. 11 depicts a process for an intermediate system to authenticate a client's access rights in the embodiment of the present invention shown in FIG. 7.

FIG. 12 depicts a process for a primary system to authenticate a client's access rights in the embodiment of the invention shown in FIG. 11.

FIG. 13 shows a process for an intermediate system to authenticate a client's access rights in the embodiment of the present invention shown in FIG. 7.

FIG. 14 shows a process for a primary system to authenticate a client's access rights in the embodiment of the invention shown in FIG. 13.

FIG. 15 depicts one embodiment of a computer system that can serve as an intermediate system, primary system, or client device, as shown in FIG. 1.

### DETAILED DESCRIPTION

A. System Overview

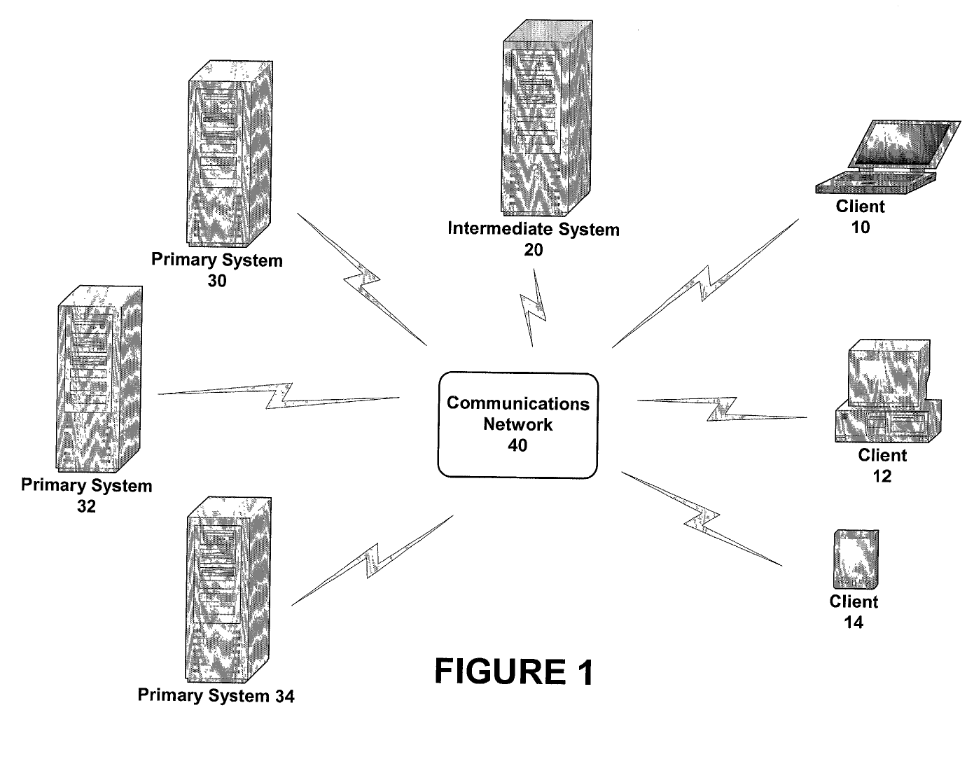

FIG. 1 depicts a system for providing clients with remote access to primary systems through an intermediate system. Client devices 10, 12, and 14, intermediate system 20, and primary systems 30, 32, and 34 are coupled to communications network 40. In one embodiment, intermediate system 20 communicates with primary systems 30, 32, and 34 over network 40 via a virtual private network. Communications network 40 can be any communications network that enables computing or communications devices to exchange information. Examples of such networks include the Internet, telecommunications networks, intranets, extranets, local area networks, and wide area networks. In an alternate embodiment, intermediate system 20 communicates with primary systems 30, 32, and 34 on one network, and intermediate system 20 communicates with client devices 10, 12, and 14 on another network.

Although client devices 10, 12, and 14 are shown as a laptop computer, personal computer, and personal digital assistant, any computing device can be used as a client device. An additional type of client device that is not shown is a cellular phone. Intermediate system 20 is not limited to the single computer system shown in FIG. 1. In alternate versions of the current invention, intermediate system 20 includes multiple computer systems. This is also true for primary systems 30, 32, and 34.

B. Client Authentication Using an Encrypted PSCI and Hashed Password

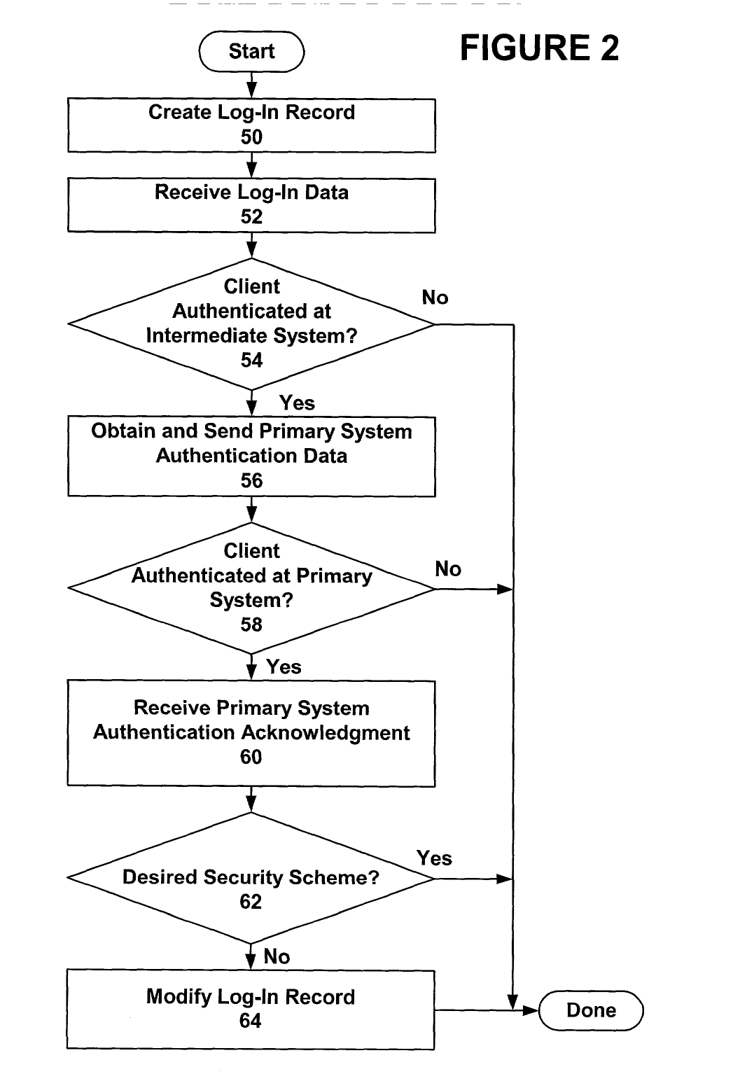

FIG. 2 illustrates process steps for providing a client with remote access to primary systems 30, 32, and 34 through intermediate system 20. In order to communicate with intermediate system 20 and primary systems 30, 32, and 34, clients use computing devices coupled to network 40, such as client devices 10, 12, and 14.

Intermediate system 20 creates log-in records for each client (step 50). In one version of the present invention, each client log-in record includes the following fields: 1) ICID—an intermediate system client identifier that identifies a client to intermediate system 20; 2) E(PSCI)—an encrypted version of the PSCI primary system client identifier described above in the Summary; 3) H1)ICP)—a hashed version of an intermediate client password (“ICP”) using hash function H1; and 4) Security ID—a security identifier corresponding to a security scheme currently employed for the client. In one embodiment, the Security ID field identifies encryption function E and hashing function H1. In further embodiments, intermediate system 20 receives pre-encrypted log-in records from primary systems for each client.

In alternate embodiments of the present invention, the client log-in record includes multiple encrypted PSCI values. Each encrypted PSCI value corresponds to a different primary system. In such an embodiment, the PSCI for each primary system can be different and the encryption techniques for each PSCI value can be different. An example of creating a client log-in record is described in detail below.

When a client attempts to log into a primary system, intermediate system 20 receives log-in data from the client (step 52). In the embodiment shown in FIG. 1, the client sends the log-in data from a client device over network 40. In one implementation, the log-in data includes an ICID client identifier and ICP client password. In embodiments where a client has accounts with multiple primary systems, the log-in data also includes a PS value identifying which primary system the client wants to access.

Using the log-in data, intermediate system 20 determines whether to authenticate the client for access to intermediate system 20 (step 54). In attempting to authenticate the client, intermediate system 20 employs the security scheme called for by the Security ID field in the client's log-in record. The steps taken to perform this authentication are described in greater detail below.

If the intermediate system authentication fails, the log-in process is terminated. If the authentication is successful, intermediate system 20 obtains primary system authentication data for the client and sends it to the primary system (step 56). The primary system authentication data is based on the client log-in record's E(PSCI) field and the ICP password provided by the client. An example of the primary system authentication data is provided below in more detail.

The primary system employs the primary system authentication data to determine whether to authenticate the client (step 58). The steps taken to perform this authentication appear below in greater detail. If the authentication fails, the log-in process is terminated. If the authentication is successful, intermediate system 20 receives an authentication acknowledgement from the primary system (step 60). The acknowledgement allows intermediate system 20 to provide the client with remote access to the primary system and services related to the primary system data.

After receiving the acknowledgement, intermediate system 20 determines whether the Security ID field in the client's log-in record corresponds to a desired security scheme (step 62). The desired security scheme is the scheme intermediate system 20 wishes to apply the next time the client attempts to log into intermediate system 20. In various embodiments of the present invention, different security schemes are employed. Examples of security schemes are described below for alternate embodiments of the present invention.

If the desired security scheme is reflected in the Security ID field, the log-in process is done. Otherwise, intermediate system 20 modifies the client's log-in record to reflect the security scheme changes (step 64). In one embodiment of the present invention, intermediate system 20 updates the Security ID field with a value corresponding to the desired security scheme. In further embodiments, intermediate system 20 also modifies the log-in record's E(PSCI) and H1(ICP) values. Intermediate system 20 encrypts PSCI and hashes ICP from the log-in data with new techniques specified by the desired security scheme.

In further implementations of the present invention, intermediate system 20 modifies the client's log-in record (step 64) even if the client is not authenticated by the primary system.

In creating a client's log-in record (step 50) in one embodiment of the present invention, intermediate system 20 receives a client identifier (“CID”) and client password (“CPW”) from a primary system. The CID and CPW values combine to form the PSCI value. Intermediate system 20 establishes ICID and ICP values for the client. In some embodiments, the client submits the ICID and/or ICP values to intermediate system 20. Intermediate system 20 also assigns a value to the Security ID field to reflect the desired security scheme for the client. Using the above-identified values, intermediate system 20 generates the log-in record, including H1(ICP) and E(PSCI). Intermediate system 20 does not maintain a record of CID, CPW, or ICP.

The E(PSCI) value generated for a client's log-in record in one version of the invention is expressed in detail as E((CID|CPW), H2(ICP)), wherein:

E((CID|CPW), H2(ICP)) is a symmetrically encrypted value with (CID|CPW) being data encrypted using encryption function E. H2(ICP) is the credential for encryption function E. Examples of symmetric encryption functions employed in embodiments of the present invention as function E include PBEWithMD5AndDES.

| represents concatenation of items adjacent to the | symbol.

H2(ICP) is a hash value resulting from hashing data value (ICP) using hash function H2. Examples of hash functions employed in embodiments of the present invention as hash function H2 include the well known MD5 and SHA1 functions.

ICP is a password known to the client and unknown to intermediate system 20.

For the E(PSCI) value shown above, the Security ID field in the client's log-in record specifies encryption function E and hashing functions H1 and H2. In one embodiment of the present invention, the Security ID contains values indicating that functions E, H1, and H2 are to be employed by intermediate system 20. In an alternate embodiment of the present invention, the Security ID contains the algorithms for encryption function E and hashing functions H1 and H2. In one embodiment of the present invention, the H1 hash function is SHA1.

Those skilled in the art will recognize that concatenated values can be concatenated in different orders in further embodiments of the present invention. Furthermore, additional components can be added to concatenated values in alternate embodiments.

In an alternate embodiment, the PSCI consists of only the client's CPW value. In this embodiment, E(PSCI) is expressed as E((CPW), H2(ICP)), and the client's CID value is maintained in the client's log-in record.

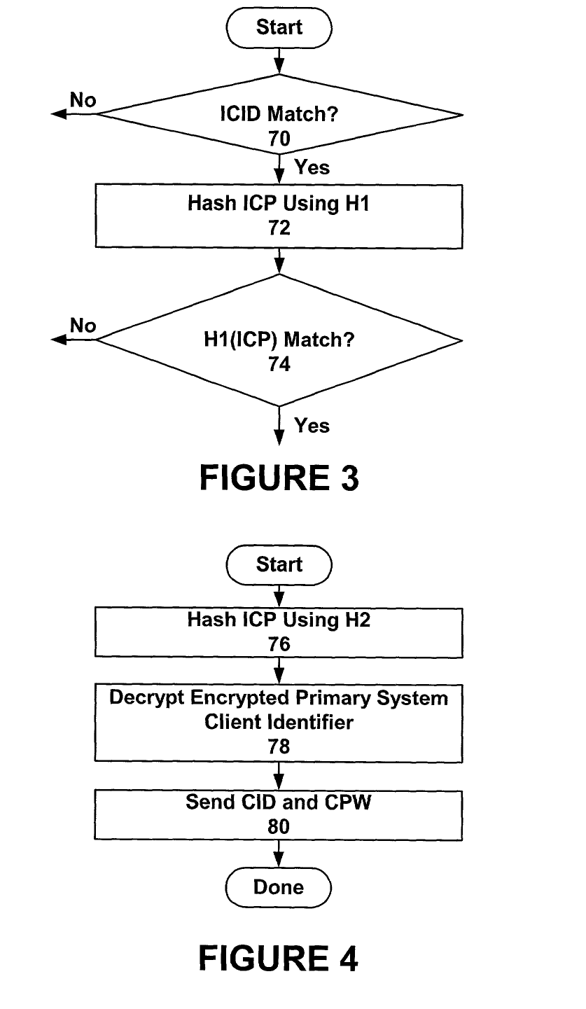

When the client attempts to log into a primary system, intermediate system 20 receives ICID and ICP from the client as part of the log-in data (step 52, FIG. 2). FIG. 3 illustrates steps performed by intermediate system 20 to carry out the client authentication operation (step 54) shown in FIG. 2. Intermediate system 20 determines whether any client log-in record has an ICID field matching the ICID value provided in the client log-in data (step 70). If no match is found, intermediate system 20 terminates the log-in process. Otherwise, intermediate system 20 applies hash function H1 to the ICP password provided in the client's log-in data (step 72). Intermediate system 20 determines whether the result of hashing the client's ICP password matches the H1(ICP) value in the client's log-in record (step 74). If the match fails, the log-in process is terminated. Otherwise, the client is successfully authenticated at intermediate system 20.

FIG. 4 shows process steps for obtaining primary system authentication data and sending it to a primary system (step 56, FIG. 2). Intermediate system 20 hashes the ICP provided in the client's log-in data using the H2 hash function identified by the Security ID (step 76). Intermediate system 20 employs the result of the H2 hash to decrypt the encrypted version of the E((CID|CPW), H2(ICP)) value (step 78). Intermediate system 20 performs the decryption with a decryption function specified by the Security ID.

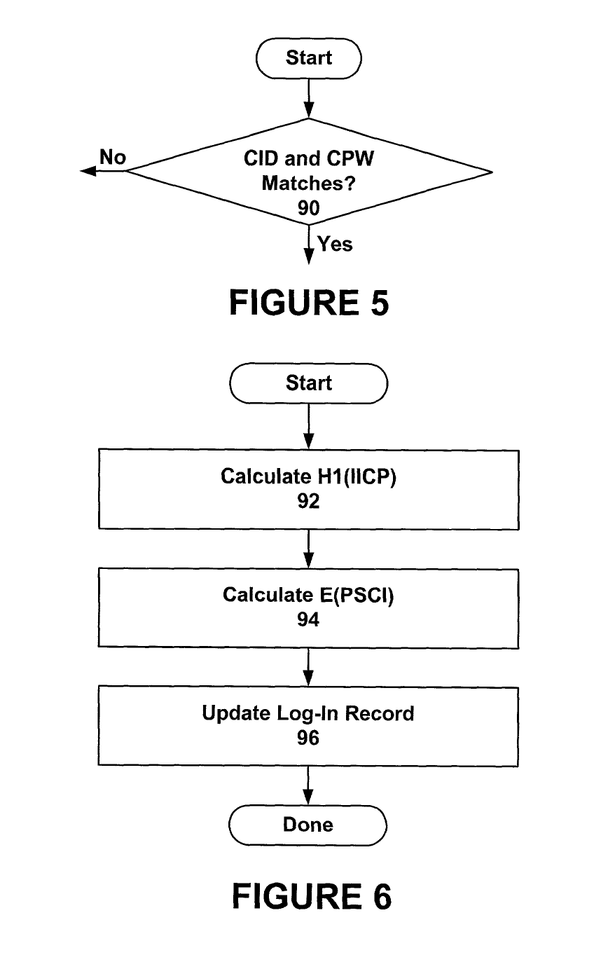

The decryption of E((CID|CPW), H2(ICP)) yields the PSCI value for authenticating the client at the primary system. Intermediate system 20 sends the PSCI value, namely CID and CPW, to the primary system (step 80). As shown in FIG. 5, the primary system authenticates the client (step 58, FIG. 2) if the CID and CPW values correspond to a client account on the primary system (step 90). If the primary system fails to find a match, the log-in process is terminated.

In the embodiment shown here, the PSCI value consists of CID and CPW. Those of ordinary skill in the art recognize that the PSCI value can be altered in various ways in other embodiments of the present invention. For example, in an alternate embodiment described above the PSCI value only includes the CPW value. In this embodiment, intermediate system 20 obtains authentication data by decrypting E(PSCI) to obtain CPW and retrieving CID for the client's log-in record. Intermediate system 20 then sends the CPW and CID values to the primary system as authentication data.

FIG. 6 shows steps executed by intermediate system 20 to modify the client log-in record when a desired security scheme replaces the current security scheme (step 64, FIG. 2). Intermediate system 20 employs the H1 hash function from the new desired security scheme to hash the ICP value provided in the client's log-in data (step 92). Using the ICP value provided in the client's log-in data eliminates the need for intermediate system 20 to separately query the client for the ICP value.

Intermediate system 20 encrypts PSCI value CID|CPW according to the encryption technique specified in the new desired security scheme (step 94). In the embodiment shown here, intermediate system 20 hashes ICP using the H2 function from the new desired security scheme. Intermediate system 20 then employs the resulting value from the H2 hash as a credential for encrypting CID|CPW with the encryption function E designated in the new desired security scheme.

Intermediate system 20 updates the client's log-in record to reflect the new desired security scheme (step 96). Intermediate system 20 updates the H1(ICP) field with the hash of ICP using the H1 hash function from the new desired security scheme. Intermediate system 20 updates the E(PSCI) field with the newly calculated E((CID|CPW), H2(ICP)) value using the E and H2 functions from the new desired security scheme. Intermediate system 20 also stores a new value in the Security ID field corresponding to the new desired security scheme.

Those skilled in the art will recognize that numerous different security scheme modifications can be implemented in accordance with the present invention. For example, the scheme may change the values hashed by functions H1 and H2, or eliminate hashing the ICP value with H1, or eliminate using an E(PSCI) value.

In an alternate embodiment of the present invention, the E(PSCI) value is generated using a cryptographic cipher. In this embodiment, the H2 hash function is replaced by the cipher creating encryption and decryption keys for use in generating and decrypting the E(PSCI) value.

In creating a client's log-in record (step 50, FIG. 2), intermediate system 20 inputs the client's ICP value into a cryptographic cipher identified by the current security scheme. The cipher generates an encryption key based on the ICP value. Intermediate system 20 employs the encryption key to encrypt the PSCI value in accordance with an encryption function specified by the current security scheme. In one implementation, the encryption function is PBEWithMD5AndDES. As discussed above, the PSCI value can include different values in different embodiments of the invention. For example, the PSCI is equal to (CID|CPW) in one embodiment and equal to (CPW) in another embodiment.

When obtaining authentication data for the primary system (step 56, FIG. 2), intermediate system 20 employs the cipher instead of the above-described H2 hash function (step 76, FIG. 4). Intermediate system 20 inputs the ICP value from the client's log-in data to the cipher, which generates a decryption key based on ICP. Intermediate system 20 uses the decryption key to decrypt the E(PSCI) value in the client's log-in record (step 78, FIG. 4).

When the client's log-in record is modified to reflect a new desired security scheme (step 64, FIG. 2), intermediate system 20 generates a new E(PSCI) value for the client's log-in record in accordance with the new desired security scheme (step 94, FIG. 6). In some embodiments, the new security scheme may call for a cipher to replace an H2 hash function being employed in the encryption process. In other embodiments, one cipher may replace another cipher. As discussed above numerous encryption schemes fall with the scope of the present invention.

If the new desired security scheme calls for a cryptographic cipher, intermediate system 20 employs the new cipher to modify the log-in record's E(PSCI) value (step 64, FIG. 2). Intermediate system 20 inputs the ICP value from the client's log-in data into the cipher, which produces an encryption key. This operation essentially replaces the above described process step of hashing the ICP with the H2 hash function. Intermediate system 20 then employs the encryption key to encrypt the PSCI value in accordance with the new desired security scheme (step 94, FIG. 6). The new encrypted value of PSCI replaces the old E(PSCI) value in the client's log-in record (step 96, FIG. 6).

Those skilled in the art will recognize that different embodiments of the present invention can employ various values in obtaining encryption and decryption keys from the cipher. For example, ICP may be replaced by a different value or a combination of ICP and a key component value known only to intermediate system 20.

Although security scheme modification steps 62 and 64 are shown in FIG. 2 as being performed on an intermediate system, embodiments of the present invention are not limited to this application. These security modification steps can also be performed on a primary system in a remote access environment—including environments where clients directly access the primary system and environments employing an intermediate system.

C. Client Authentication Using an Encrypted PSCI

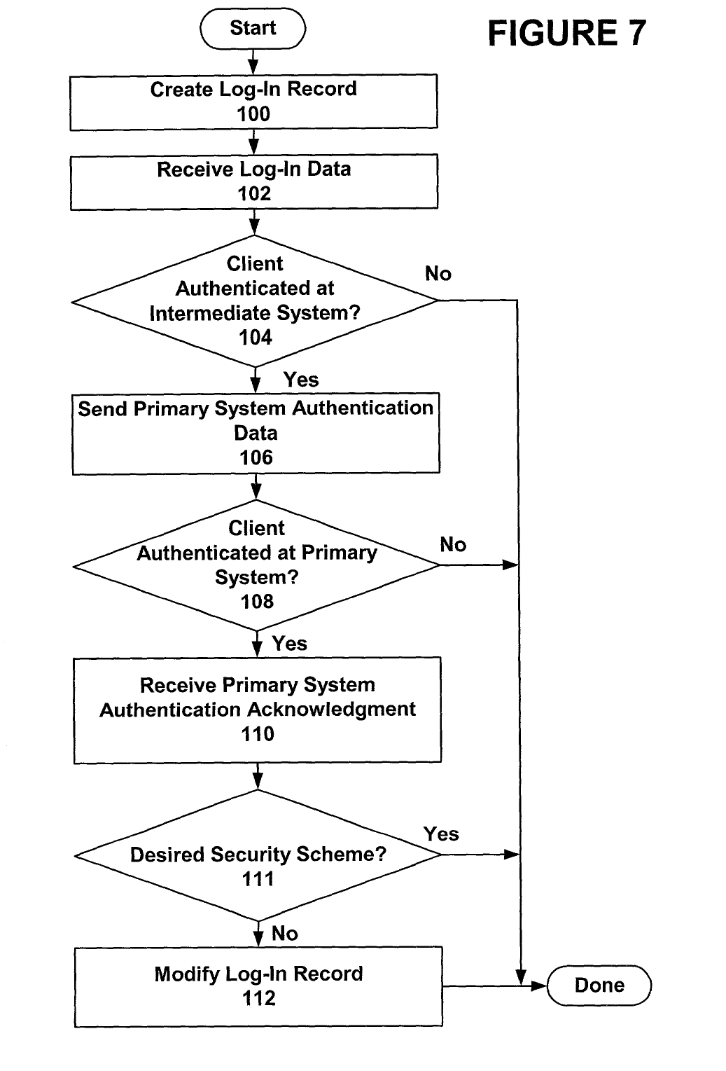

FIG. 7 illustrates an alternate embodiment of process steps for providing a client with remote access to primary systems 30, 32, and 34 through intermediate system 20. In this embodiment, the client's log-in record does not include a hashed version of the ICP password.

Intermediate system 20 creates log-in records for each client (step 100). Each client receives a separate log-in record for each primary system the client wishes to access. In one version of the present invention, each log-in record includes the following fields: 1) ICID—an intermediate system client identifier that identifies a client; 2) PS—a primary system identifier that identifies a primary system; 3) E(PSCI)—an encrypted version of the PSCI primary system client identifier described above in the Summary; and 4) Security ID—a security identifier indicating a security scheme currently employed for the client.

In alternate embodiments of the present invention, the encrypted version of the PSCI is different, as will be described in detail below. The PS field can be omitted in embodiments of the present invention including only a single primary system. When a client attempts to log into a primary system, intermediate system 20 receives log-in data from the client (step 102). In the embodiment shown in FIG. 1, the client sends the log-in data from a client device over network 40. In one implementation, the log-in data includes ICID and PS values, as well as an encryption key component.

Using the log-in data, intermediate system 20 determines whether to authenticate the client for access to intermediate system 20 (step 104). In attempting to authenticate the client, intermediate system 20 employs the security scheme corresponding to the Security ID field in the client's log-in record. The steps taken to perform this authentication are described in greater detail below for various embodiments of the present invention. If the authentication fails, the log-in process is terminated. If the authentication is successful, intermediate system 20 sends primary system authentication data to the primary system identified in the log-in data (step 106). The primary system authentication data is based on the log-in record's E(PSCI) field and the encryption key component provided by the client. The primary system authentication data varies among different embodiments and is described below in greater.

Employing the primary system authentication data, the primary system determines whether to authenticate the client (step 108). The steps taken to perform this authentication appear below in greater detail for various embodiments of the present invention. If the authentication fails, the log-in process is terminated. If the authentication is successful, intermediate system 20 receives an authentication acknowledgement from the primary system (step 110). The acknowledgement allows intermediate system 20 to provide the client with remote access to the identified primary system and services related to the primary system data.

After receiving the acknowledgement, intermediate system 20 determines whether the Security ID field in the client's log-in record corresponds to a desired security scheme (step 111). Examples of security schemes are described below for alternate embodiments of the present invention.

If the desired security scheme is reflected in the Security ID field, the log-in process in complete. Otherwise, intermediate system 20 modifies the client's log-in record to reflect the security scheme changes (step 112). In one embodiment of the present invention, intermediate system 20 updates the Security ID field with a value corresponding to the desired security scheme. In further embodiment, intermediate system 20 also modifies the encrypted PSCI value by encrypting PSCI with a new technique specified by the desired security scheme.

In alternate implementations of the present invention, intermediate system 20 modifies the client's log-in record (step 112) even if the client is not authenticated by the primary system.

1. Using A Non-Encrypted PSCI Value

In one embodiment of the present invention, PSCI is a non-encrypted value containing client identifier CID and client password CPW. Intermediate system 20 decrypts E(PSCI) to obtain the CID and CPW values when authenticating a client's access rights (step 104). Intermediate system 20 then sends the CID and CPW values to a primary system (step 106) for use in authenticating the client (step 108). This embodiment is described in more detail below.

In creating a log-in record for a client (step 100), intermediate system 20 receives PS, CID, and CPW values from the client's primary system. The CID and CPW values combine to form the PSCI. Intermediate system 20 assigns the client an ICID value and an ICP value. In some embodiments, the ICID and/or ICP are submitted by a client prior to their assignment by intermediate system 20. Intermediate system 20 also assigns a value to the Security ID field to reflect the desired security scheme. Using the above-identified values, intermediate system 20 generates the log-in record. Intermediate system 20 does not maintain a record of CID, CPW, or ICP.

In this embodiment, the E(PSCI) value generated for a client's log-in record is expressed in detail as E((tt|CID|CPW), H(IKEY|ICP)), wherein:

E((tt|CID|CPW), H(IKEY|ICP)) is a symmetrically encrypted value with (tt|CID|CPW) being data encrypted using encryption function E. H(IKEY|ICP) is the key for encryption function E. Examples of symmetric encryption functions employed in embodiments of the present invention as function E include the well known DES and AES functions.

tt is a redundant telltale character string used in verifying the accurate decryption of E((tt|CID|CPW), H(IKEY|ICP)).

H(IKEY|ICP) is a hash value resulting from hashing data value (IKEY|ICP) using hash function H. Examples of hash functions employed in embodiments of the present invention as hash function H include the well known MD5 and SHA1 functions.

IKEY is an encryption key component known to intermediate system 20.

ICP is as an encryption key component known to the client and unknown to intermediate system 20.

In this embodiment, the Security ID field in the client's log-in record specifies encryption function E and hashing function H. In one embodiment of the present invention, the Security ID contains values indicating function E and H are to be employed by intermediate system 20. In an alternate embodiment of the present invention, the Security ID contains the algorithms for encryption function E and hashing function H.

When the client attempts to log into a primary system, intermediate system 20 receives PS, ICID and ICP from the client as the log-in data (step 102, FIG. 7).

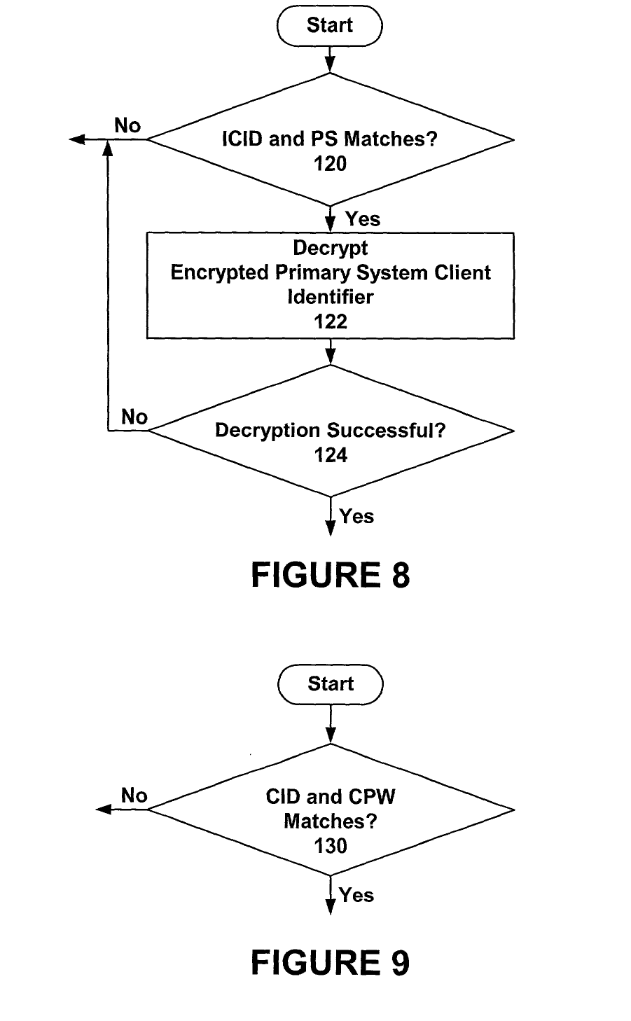

FIG. 8 illustrates steps performed by intermediate system 20 to carry out the client authentication operation (step 104) shown in FIG. 7. Intermediate system 20 determines whether a client log-in record exists with the combination of the ICID and PS provided by the client (step 120). If the log-in record does not exist, the log-in process is terminated. Otherwise, intermediate system 20 decrypts the E(PSCI) value in the client's log-in record (step 122). Intermediate system 20 employs the security scheme identified in the client log-in record's Security ID field to perform the decryption (step 122). In performing the decryption, intermediate system 20 performs hash function H(IKEY|ICP) to obtain a key. Intermediate system 20 then uses this key to decrypt the encrypted E((tt|CID|CPW), H(IKEY|ICP)) value in the client's log-in record.

Intermediate system 20 determines whether the decryption was successful (step 124)—comparing the telltale component of the decryption result with the known tt telltale value described above. If the values do not match, the log-in process is terminated. If the values match, the client's right to access the intermediate system is authenticated. A successful decryption yields CID and CPW, which intermediate system 20 sends to the selected primary system as authentication data (step 106, FIG. 7). Upon receiving CID and CPW, the primary system attempts to authenticate the client's access rights (step 108).

FIG. 9 shows the authentication step taken by the primary system to carry out the authentication operation (step 108) shown in FIG. 7. The primary system determines whether CID and CPW correspond to values for a client authorized to access the primary system (step 130). If a match is found, the client is authenticated and an acknowledgement is sent to intermediate system 20 (step 110, FIG. 7). Otherwise, the log-in process is terminated.

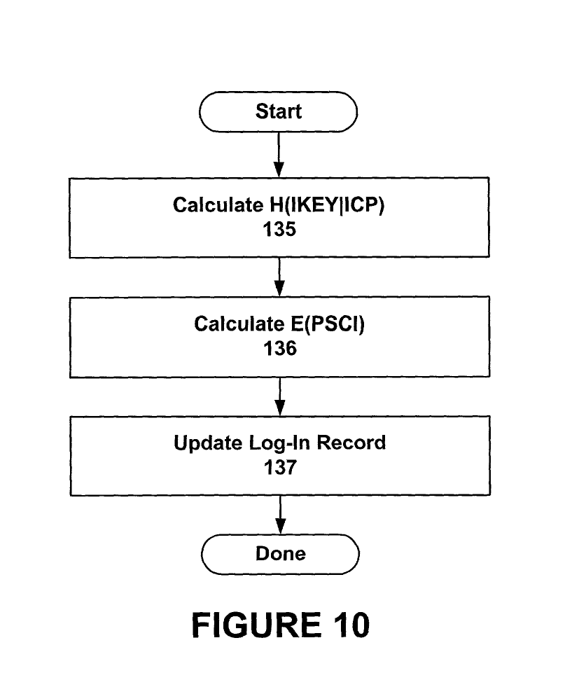

FIG. 10 depicts the steps taken by intermediate system 20 to perform the log-in record modification (step 112) shown in FIG. 7. Using hash function H as specified by the new desired security scheme, intermediate system 20 hashes the value (IKEYIICI) (step 135). Intermediate system 20 also encrypts the PSCI according to encryption technique E as specified in the new desired security scheme (step 136). Intermediate system 20 then updates the client's log-in record with the resulting E(PSCI) value from the new hash and encryption operations from steps 135 and 136 (step 137). Intermediate system 20 also stores a new value in the log-in record's Security ID field corresponding to the new desired security scheme (step 137).

2. Using A PSCI Value that is Encrypted

In an implementation of the present invention, PSCI is an encrypted value. Intermediate system 20 decrypts E(PSCI) when authenticating a client's access rights (step 104). The decryption yields the encrypted PSCI value. Intermediate system 20 then sends the encrypted PSCI value to a primary system (step 106) for use in authenticating the client (step 108). During the authentication, the primary system decrypts PSCI to obtain a CID client identifier and CPW client password. Using an encrypted PSCI value eliminates the transfer of decrypted CID and CPW values by intermediate system 20 on network 40. This embodiment is described in more detail below.

In creating a log-in record for a client (step 100), intermediate system 20 receives PS and PSCI values from the client's primary system. The PSCI value is an encryption of the CID and CPW for the client. In one implementation PSCI is expressed in detail as F((CID|CPW), K), wherein:

F((CID|CPW), K) is an encrypted value with (CID|CPW) being data encrypted using encryption function F and K being the key for encryption function F. In one version of the present invention, encryption function F is symmetric, while in alternate versions encryption function F is asymmetric. Examples of encryption functions employed in embodiments of the present invention as encryption function F include the well known AES and RSA functions.

K is the key used for encryption function F. Encryption key K and a corresponding decryption key for encryption function F are known to the primary system and not known to intermediate system 20.

Intermediate system 20 also assigns Security ID, ICID and ICP values for the client during creation of the log-in record. Using the Security ID, PS, PSCI, ICID, and ICP values, intermediate system 20 generates the log-in record. Intermediate system 20 does not maintain a record of PSCI or ICP.

In this embodiment, the E(PSCI) value generated for a client's log-in record is expressed in detail as E((tt|F((CID|CPW), K)), H(IKEY|ICP)), wherein:

E((tt|F((CID|CPW), K)), H(IKEY|ICP)) is a symmetrically encrypted value with (tt|F((CID|CPW), K)) being data encrypted using encryption function E. H(IKEY|ICP) is the key for encryption function E, as described above. Examples of symmetric encryption functions employed in embodiments of the present invention as function E include the well known DES and AES functions. The Security ID field in the client's log-in record specifies the encryption function E and hashing function H.

When the client attempts to remotely log into a primary system, intermediate system 20 receives PS, ICID and ICP from the client as the login data (step 102, FIG. 7).

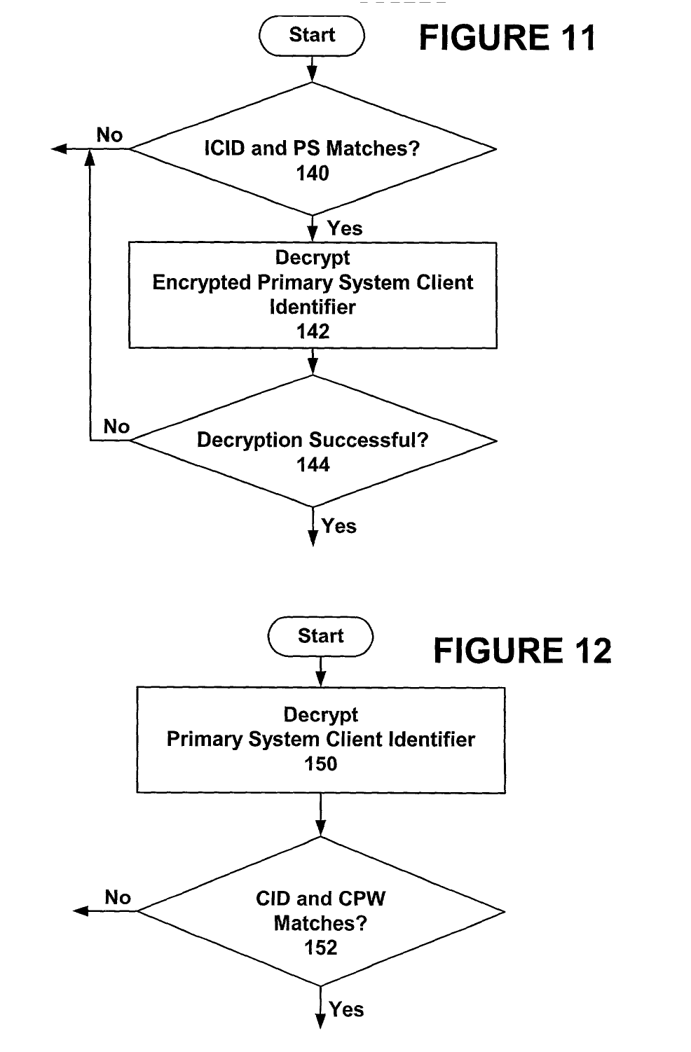

FIG. 11 illustrates steps performed by intermediate system 20 to carry out the client authentication operation (step 104) shown in FIG. 7. Intermediate system 20 determines whether a client log-in record exists with the combination of the ICID and PS provided by the client (step 140). If the log-in record does not exist, the log-in process is terminated. Otherwise, intermediate system 20 decrypts the E(PSCI) value in the client's log-in record (step 142). Intermediate system 20 employs the security scheme identified in the client log-in record's Security ID field to perform the decryption (step 142). In performing the decryption, intermediate system 20 performs hash function H(IKEY|ICP) to obtain a key. Intermediate system 20 then uses this key to decrypt the encrypted E((tt|F((CID|CPW), K)), H(IKEY|ICP)) value in the client's log-in record.

Intermediate system 20 then determines whether the decryption was successful (step 144). Intermediate system 20 compares the telltale component of the decryption result with the known tt telltale value described above. If the values do not match, the log-in process is terminated. If the values match, the client's right to access the intermediate party is authenticated. A successful decryption yields PSCI value F((CID|CPW), K). Intermediate system 20 sends the decryption result to the selected primary system (step 106, FIG. 7). Upon receiving the F((CID|CPW), K) value, the primary system attempts to authenticate the client's access rights (step 108).

FIG. 12 shows the authentication steps taken by the primary system to perform the client authentication operation (step 108) shown in FIG. 7. The primary system decrypts the F((CID|CPW), K) value to obtain CID and CPW (step 150). The primary system then determines whether CID and CPW correspond to values for a client authorized to access the primary system (step 152). If a match is found, the client is authenticated and an acknowledgement is sent to intermediate system 20. Otherwise, the log-in process is terminated.

As described above, FIG. 10 depicts the steps taken by intermediate system 20 to perform the log-in record modification (step 112) shown in FIG. 7.

3. The Intermediate System is Unable to Verify Decryption of E(PSCI)

In this embodiment of the present invention, intermediate system 20 cannot verify the decryption of the E(PSCI) field in a client log-in record. Intermediate system 20 authenticates the client's access rights (step 104)—determining whether ICID and PS values supplied by the client correspond to a client log-in record. Intermediate system 20 sends the encrypted E(PSCI) value to a primary system (step 106) for use in authenticating the client (step 108). During the authentication, the primary system decrypts E(PSCI) to obtain a CID client identifier and a CPW client password. Sending the E(PSCI) value to the primary system further reduces the exposure of the PSCI value on network 40. This embodiment is described in more detail below.

In creating a log-in record for a client (step 100), intermediate system 20 receives PS and PSCI values from the client's primary system. The PSCI value is an encryption employing CID and CPW values for the client. In one implementation PSCI is expressed in detail as F((tt|CID|CPW), K), wherein:

F((tt|CID|CPW), K) is an encrypted value with (tt|CID|CPW) being data encrypted using encryption function F and K being the key for encryption function F. In one version of the present invention, encryption function F is symmetric, while in alternate versions encryption function F is asymmetric. Examples of encryption functions employed in embodiments of the present invention as function F include the well known AES and RSA functions.

K is the key used for encryption function F. Encryption key K and a corresponding decryption key for encryption function F are known to the primary system and unknown to intermediate system 20. tt is a telltale value, as described above. In this embodiment, however, the tt value is known to the primary system and unknown to intermediate system 20.

Intermediate system 20 also assigns Security ID, ICID and ICP values for the client during creation of the log-in record. Using the Security ID, PS, PSCI, ICID, and ICP values, intermediate system 20 generates the log-in record. Intermediate system 20 does not maintain a record of PSCI or ICP.

In this embodiment, the E(PSCI) value generated for a client's log-in record is expressed in detail as E(F((tt|CID|CPW), K), H(IKEY|ICP)), wherein:

E(F((tt|CID|CPW), K), H(IKEY|ICP)) is a symmetrically encrypted value with (F(tt|CID|CPW), K) being data encrypted using encryption function E. H(IKEY|ICP) is the key for encryption function E, as described above. Examples of symmetric encryption functions employed in embodiments of the present invention as function E include the well known DES and AES functions. The Security ID field in the client's log-in record specifies the encryption function E and hashing function H.

When the client attempts to log into a primary system, intermediate system 20 receives PS, ICID and ICP from the client as the log-in data (step 102, FIG. 2).

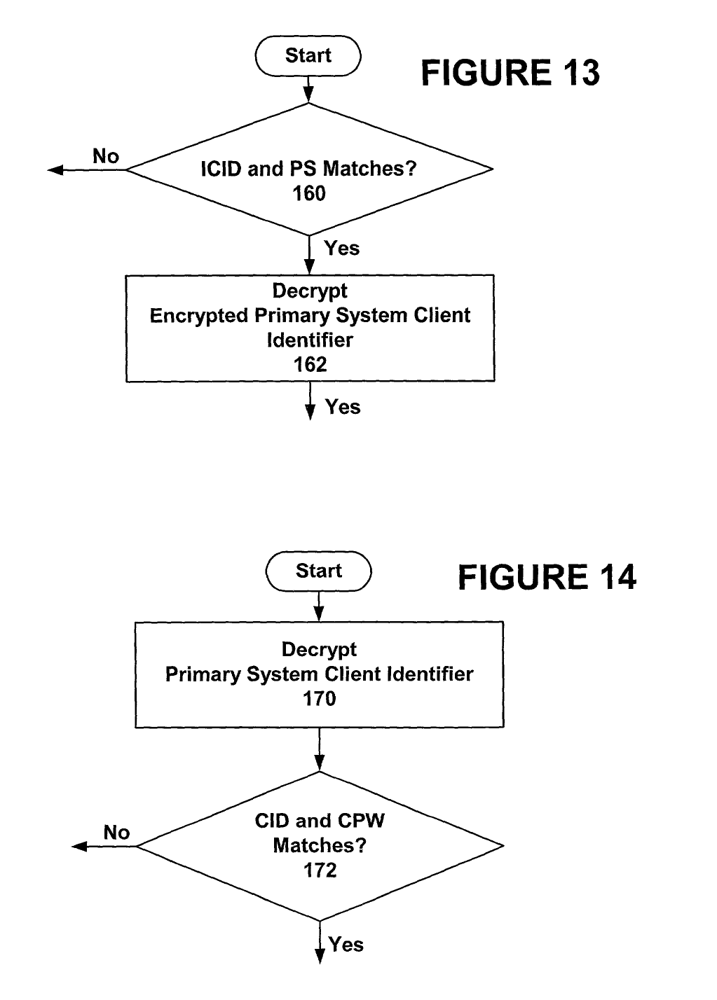

FIG. 13 illustrates steps performed by intermediate system 20 to carry out the client authentication operation (step 104) shown in FIG. 7. Intermediate system 20 determines whether a client log-in record exists with the combination of the ICID and PS provided by the client (step 160). If the log-in record does not exist, the log-in process is terminated. Otherwise, intermediate system 20 decrypts the log-in record's E(PSCI) value (step 162). Intermediate system 20 employs the security scheme identified in the client log-in record's Security ID field to perform the decryption (step 162). In performing the decryption (step 162), intermediate system 20 performs hash function H(IKEY|ICP) to obtain a key. Intermediate system 20 then uses this key to decrypt the E(F((tt|CID|CPW), K), H(IKEY|ICP)) value in the client's log-in record. The decryption yields the F((tt|CID|CPW), K) value.

Unlike previous embodiments, intermediate system 20 is unable to determine whether the decryption was successful. Intermediate system 20 does not know the telltale value for measuring the success of the decryption. Intermediate system 20 sends the resulting F((tt|CID|CPW), K) value to the selected primary system (step 106, FIG. 7). Upon receiving the decryption result, the primary system attempts to authenticate the client's access rights (step 108).

FIG. 14 shows the authentication steps taken by the primary system to carry out the authentication of the client (step 108) shown in FIG. 7. The primary system decrypts the F((tt|CID|CPW), K) value to obtain CID and CPW (step 170). The primary system then determines whether CID and CPW correspond to values for a client authorized to access the primary system (step 172). If a match is found, the client is authenticated and an acknowledgement is sent to intermediate system 20. Otherwise, the log-in process is terminated.

In determining whether matches exist for CID and CPW in one embodiment, the primary system first ensures the decryption was successful. The primary system accomplishes this by verifying that the decrypted PSCI value has a telltale value that matches the know tt telltale value. In an alternate embodiment, the primary system determines that the decryption was successful by finding a client record with a CID and CPW pair that matches the CID and CPW generated from the decryption.

As described above, FIG. 10 depicts the steps taken by intermediate system 20 to perform the log-in record modification (step 112) shown in FIG. 7.

D. Computer System

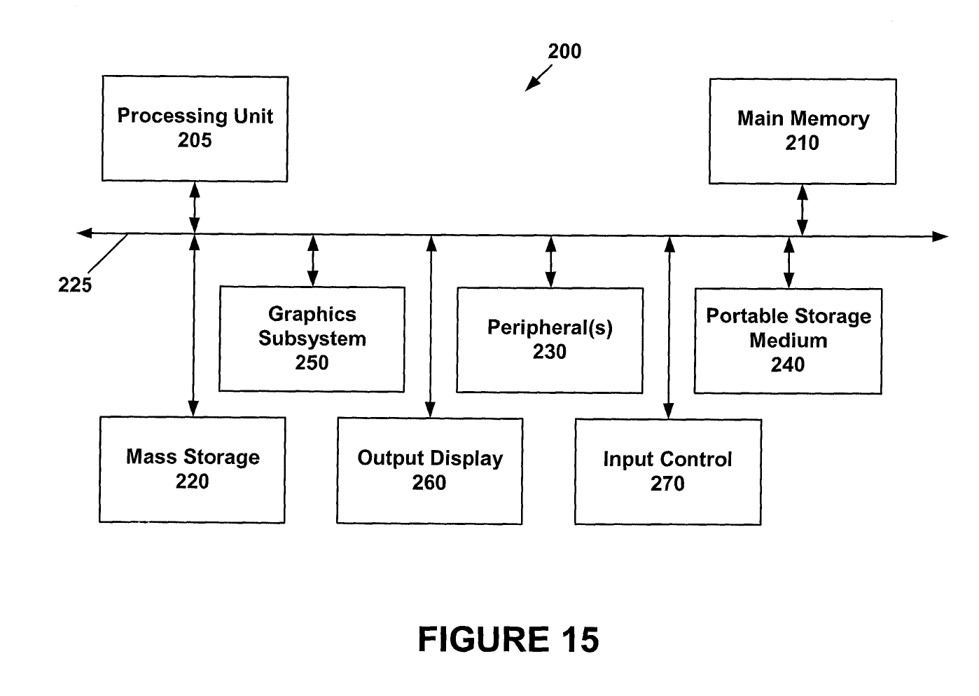

FIG. 15 illustrates a high level block diagram of general purpose computer system 200. System 200 may be employed in embodiments of the present invention as intermediate system 20. System 200 may also be employed as a primary system (30, 32, and 34) or a client device (10, 12, and 14). Accordingly, computer system 200 may be employed for performing a number of processes, including those illustrated in FIGS. 2-14.

Computer system 200 contains processing unit 205, main memory 210, and interconnect bus 225. Processing unit 205 may contain a single microprocessor or a plurality of microprocessors for configuring computer system 200 as a multi-processor system. In one embodiment, processing unit 205 includes a specialized cryptographic processor to accelerate the calculation of encryption functions. Processing unit 205 is employed in conjunction with a memory or other data storage medium containing application specific program code instructions to implement either intermediate system 20, a primary system (30, 32, and 34), or a client device (10,12, and 14).

Main memory 210 stores, in part, instructions and data for execution by processing unit 205. If a process, such as the processes illustrated in FIGS. 2-14, is wholly or partially implemented in software, main memory 210 can store the executable instructions for implementing the process when the computer is in operation. For example, main memory 210 can store program code instructions employed by intermediate system 20. In one implementation, main memory 210 includes banks of dynamic random access memory (DRAM) as well as high speed cache memory.

Computer system 200 further include mass storage device 220, peripheral device(s) 230, portable storage medium drive(s) 240, input control device(s) 270, graphics subsystem 250, and output display 260. For purposes of simplicity, all components in computer system 200 are shown in FIG. 15 as being connected via bus 225. However, computer system 200 may be connected through one or more data transport means in alternate implementations. For example, processing unit 205 and main memory 210 may be connected via a local microprocessor bus, and mass storage device 220, peripheral device(s) 230, portable storage medium drive(s) 240, and graphics subsystem 250 may be connected via one or more input/output busses.

Mass storage device 220 is a non-volatile storage device for storing data and instructions for use by processing unit 205. Mass storage device 220 can be implemented in a variety of ways, including a magnetic disk drive or an optical disk drive. In software embodiments of the present invention, mass storage device 220 stores the instructions executed by computer system 200 to perform processes such as those illustrated in FIGS. 2-14.

Portable storage medium drive 240 operates in conjunction with a portable non-volatile storage medium to input and output data and code to and from computer system 200. Examples of such storage mediums include floppy disks, compact disc read only memories (CD-ROM) and integrated circuit non-volatile memory adapters (i.e. PC-MCIA adapter). In one embodiment, the instructions for enabling computer system 200 to execute processes, such as those illustrated in FIGS. 2-14, are stored on such a portable medium, and are input to computer system 200 via portable storage medium drive 240.

Peripheral device(s) 230 may include any type of computer support device, such as an input/output interface, to add additional functionality to computer system 200. For example, peripheral device(s) 230 may include a communications controller, such as a network interface card or integrated circuit, for interfacing computer system 200 to a communications network. Instructions for enabling computer system 200 to perform processes, such as those illustrated in FIGS. 2-14, may be downloaded into the computer system's main memory 210 over a communications network. Computer system 200 may also interface to a database management system over a communications network or other medium that is supported by peripheral device(s) 230. Input control device(s) 270 provide a portion of the user interface for a user of computer system 200. Input control device(s) 270 may include an alphanumeric keypad for inputting alphanumeric and other key information, a cursor control device, such as a mouse, a trackball, stylus, or cursor direction keys. In order to display textual and graphical information, computer system 200 contains graphics subsystem 250 and output display 260. Output display 260 can include a cathode ray tube display or liquid crystal display. Graphics subsystem 250 receives textual and graphical information, and processes the information for output to output display 260.

The components contained in computer system 200 are those typically found in general purpose computer systems. In fact, these components are intended to represent a broad category of such computer components that are well known in the art.

The process steps and other functions described above with respect to embodiments of the present invention may be implemented as software instructions. More particularly, the process steps illustrated in FIGS. 2-14 may be implemented as software instructions. For one software implementation, the software includes a plurality of computer executable instructions for implementation on a general purpose computer system. Prior to loading into a general purpose computer system, the software instructions may reside as encoded information on a computer readable medium, such as a magnetic floppy disk, magnetic tape, and compact disc read only memory (CD-ROM). In one hardware implementation, circuits may be developed to perform the process steps and other functions described herein.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A computer implemented method for updating a current security scheme on a computer system, said computer implemented method comprising the steps of:
(a) receiving log-in data for a client during a first log-in attempt;
(b) authenticating said client, wherein said step (b) includes the steps of:
(1) applying a first function to a value in said log-in data to obtain a first result, and
(2) employing said first result in determining whether to authenticate said client during said first log-in attempt;
(c) determining that said current security scheme is to be replaced by a desired security scheme; and
(d) modifying at least one record in said computer system in response to said step (c), wherein said step (d) includes the step of:
(1) applying a second function to said value received in said step (a) to obtain a second result.

2. The computer implemented method of claim 1, wherein said computer system maintains a log-in record, wherein said step (b)(2) includes the steps of:
(i) comparing said first result obtained in said step (b)(1) to a first value stored in said log-in record.

3. The computer implemented method of claim 2, wherein said step (d) includes the step of:
(2) replacing said first value in said log-in record with said second result obtained in said step (d)(1).

4. The computer implemented method of claim 3, wherein said first function is a first hash function and said second function is a second hash function different than said first hash function.

5. The computer implemented method of claim 2, wherein said step (b) includes the steps of:
(3) applying a third function to said value in said log-in data to obtain a first credential; and
(4) decrypting a third value in said log-in record to obtain a decrypted value, wherein said step (b)(4) employs said first credential.

6. The computer implemented method of claim 5, wherein said step (b) further includes the step of:
(5) forwarding said decrypted value to a primary computer system.

7. The computer implemented method of claim 5, wherein said step (d) includes the steps of:
(2) replacing said first value in said log-in record with said second result obtained in said step (d)(1);
(3) applying a fourth function to said value in said log-in record to obtain a second credential;
(4) encrypting a quantity to obtain a fourth value, wherein said step (d)(4) employs said second credential; and
(5) replacing said third value in said log-in record with said fourth value.

8. The computer implemented method of claim 7, wherein:
said first function is a first hash function and said second function is a second hash function different than said first hash function, and said third function is a third hash function and said fourth function is a fourth hash function different than said third hash function.

9. The computer implemented method of claim 2, wherein said step (b) includes the steps of:
(3) inputting said value in said log-in data into a first cryptographic cipher to obtain a first encryption key; and
(4) decrypting a third value in said log-in record to obtain a decrypted value, wherein said step (b)(4) employs said first encryption key.

10. The computer implemented method of claim 9, wherein said step (b) further includes the step of:
(5) forwarding said decrypted value to a primary computer system.

11. The computer implemented method of claim 9, wherein said step (d) includes the steps of:
(2) replacing said first value in said log-in record with said second result obtained in said step (d)(1);
(3) inputting said value in said log-in data into a second cryptographic cipher to obtain a second encryption key;
(4) encrypting a quantity to obtain a fourth value, wherein said step (d)(4) employs said second encryption key; and
(5) replacing said third value in said log-in record with said fourth value.

12. The computer implemented method of claim 1, wherein said computer system maintains a log-in record, wherein said step (b)(2) includes the steps of:
(i) decrypting a first value in said log-in record to obtain a decrypted value, wherein said step (b)(2)(i) employs said first result as a decryption key; and
(ii) forwarding said decrypted value to a primary computer system.

13. The computer implemented method of claim 12, wherein said step (d) includes the steps of:
(2) encrypting a quantity to obtain a second value, wherein said step (d)(3) employs said second result obtained in said step (d)(1); and
(3) replacing said first value in said log-in record with said second value.

14. The computer implemented method of claim 13, wherein:
said first function is a first hash function and said second function is a second hash function different than said first hash function, and
said third function is a third hash function and said fourth function is a fourth hash function different than said third hash function.

15. The computer implemented method of claim 11, wherein:
said first function is a first cryptographic cipher and said second function is a second cryptographic cipher different than said first cryptographic cipher, and
said third function is a third cryptographic cipher and said fourth function is a fourth cryptographic cipher different than said third cryptographic cipher.

16. The computer implemented method of claim 1, further including the steps of:
(e) receiving log-in data for said client during a second log-in attempt;
(f) authenticating said client during said second log-in attempt, wherein said step (f) includes the steps of:
(1) applying said second function to a value in said log-in data received in said step (e) to obtain a third result, and
(2) employing said third result in determining whether to authenticate said client during said second log-in attempt.

17. The computer implemented method of claim 1, wherein said computer system includes a log-in record corresponding to said client, wherein said log-in record includes a first entry identifying said current security scheme, said computer implemented method further including the step of:
(g) replacing said first entry in said log-in record with a second entry identifying said desired security scheme.

18. A computer implemented method for providing a client with access to a primary system through an intermediate system, said computer implemented method comprising the steps of:
(a) creating a log-in record, wherein said log-in record includes a security identifier and a first encrypted value, wherein said security identifier corresponds to a current security scheme employed by said intermediate system;
(b) receiving log-in data for said client;
(c) authenticating access of said client to said intermediate system, based on data from said log-in data and data from said log-in record;
(d) obtaining authentication data to send to said primary system, wherein said authentication data includes data from a decrypted version of said first encrypted value;
(e) determining that said current security scheme is to be replaced by a desired security scheme; and
(f) modifying said log-in record, wherein said step (f) includes the steps of:
(1) updating said security identifier to correspond to said desired security scheme,
(2) employing data in said log-in data received in said step (b) to calculate a second encrypted value, and
(3) replacing said first encrypted value with said second encrypted value.

19. The computer implemented method of claim 18, wherein said step (c) includes the steps of:
(1) applying a first function to a value in said log-in data to obtain a first result, and
(2) comparing said first result obtained in said step (c)(1) to a first value stored in said log-in record.

20. The computer implemented method of claim 19, wherein said step (f) includes the steps of:
(4) applying a second function to said value in said log-in data to obtain a second result; and
(5) replacing said first value in said log-in record with said second result obtained in said step (d)(4).

21. The computer implemented method of claim 20, wherein said first function is a first hash function and said second function is a second hash function different than said first hash function.

22. The computer implemented method of claim 20, wherein said step (d) includes the steps of:
(3) applying a third function to said value in said log-in data to obtain a first credential; and
(4) decrypting said first encrypted value in said log-in record to obtain a first decrypted value, wherein said step (d)(4) employs said first credential, wherein said authentication data includes said first decrypted value.

23. The computer implemented method of claim 22,
wherein said step (f)(2) includes the steps of:
(i) applying a fourth function to said value in said log-in record to obtain a second credential; and
(ii) encrypting a quantity to obtain said second encrypted value, wherein said step (f)(2)(ii) employs said second credential.

24. The computer implemented method of claim 23, wherein said third function is a third hash function and said fourth function is a fourth hash function different than said third hash function.

25. The computer implemented method of claim 20, wherein said step (d) includes the steps of:
(3) inputting said value in said log-in data to a first cryptographic cipher to obtain a first decryption key; and
(4) decrypting said first encrypted value in said log-in record to obtain a first decrypted value, wherein said step (d)(4) employs said first decryption key, wherein said authentication data includes said first decrypted value.

26. The computer implemented method of claim 25,
wherein said step (f)(2) includes the steps of:
(i) inputting said value in said log-in record to a second cryptographic cipher to obtain said second encryption key;
(ii) encrypting a quantity to obtain said second encrypted value, wherein said step (f)(2)(ii) employs said second encryption key.

27. The computer implemented method of claim 18, wherein said step (d) includes the steps of:
(1) applying a first function to a value in said log-in data to obtain a first credential; and
(2) decrypting said first encrypted value in said log-in record to obtain a first decrypted value, wherein said step (d)(2) employs said first credential, wherein said authentication data includes said first decrypted value.

28. The computer implemented method of claim 27,
wherein said step (f)(2) includes the steps of:
(i) applying a second function to said value in said log-in record to obtain a second credential; and
(ii) encrypting a quantity to obtain said second encrypted value, wherein said step (f)(2)(ii) employs said second credential.

29. The computer implemented method of claim 28, wherein said first function is a first hash function and said second function is a second hash function different than said first hash function.

30. The computer implemented method of claim 28, wherein said first function is a first cryptographic cipher and said second function is a second cryptographic cipher different than said first cryptographic cipher.

31. A processor readable storage medium having processor readable code embodied on said processor readable storage medium, said processor readable code for programming a processor to perform a method for updating a current security scheme on a computer system, said method comprising the steps of:
(a) receiving log-in data for a client during a first log-in attempt;
(b) authenticating said client, wherein said step (b) includes the steps of:
(1) applying a first function to a value in said log-in data to obtain a first result, and
(2) employing said first result in determining whether to authenticate said client during said first log-in attempt;
(c) determining that said current security scheme is to be replaced by a desired security scheme; and
(d) modifying at least one record in said computer system in response to said step (c), wherein said step (d) includes the step of:
(1) applying a second function to said value received in said step (a) to obtain a second result.

32. The processor readable storage medium of claim 31, wherein said computer system maintains a log-in record, wherein said step (b)(2) includes the steps of:
(i) comparing said first result obtained in said step (b)(1) to a first value stored in said log-in record, and
wherein said step (d) includes the step of:
(2) replacing said first value in said log-in record with said second result obtained in said step (d)(1).

33. The processor readable storage medium of claim 32, wherein said first function is a first hash function and said second function is a second hash function different than said first hash function.

34. The processor readable storage medium of claim 32, wherein said step (b) includes the steps of:
(3) applying a third function to said value in said log-in data to obtain a first credential; and
(4) decrypting a third value in said log-in record to obtain a decrypted value, wherein said step (b)(4) employs said first credential, and
wherein said step (d) includes the steps of:
(3) applying a fourth function to said value in said log-in record to obtain a second credential;
(4) encrypting a quantity to obtain a fourth value, wherein said step (d)(4) employs said second credential; and
(5) replacing said third value in said log-in record with said fourth value.

35. The processor readable storage medium of claim 34, wherein:
said first function is a first hash function and said second function is a second hash function different than said first hash function, and
said third function is a third hash function and said fourth function is a fourth hash function different than said third hash function.

36. The processor readable storage medium of claim 32, wherein said step (b) includes the steps of:
(3) inputting said value in said log-in data into a first cryptographic cipher to obtain a first encryption key; and
(4) decrypting a third value in said log-in record to obtain a decrypted value, wherein said step (b)(4) employs said first encryption key, and
wherein said step (d) includes the steps of:
(3) inputting said value in said log-in data into a second cryptographic cipher to obtain a second encryption key;
(4) encrypting a quantity to obtain a fourth value, wherein said step (d)(4) employs said second encryption key; and
(5) replacing said third value in said log-in record with said fourth value.

37. The processor readable storage medium of claim 31, wherein said computer system maintains a log-in record, wherein said step (b)(2) includes the steps of:
(i) decrypting a first value in said log-in record to obtain a decrypted value, wherein said step (b)(2)(i) employs said first result as a decryption key; and
(ii) forwarding said decrypted value to a primary computer system, and
wherein said step (d) includes the steps of:
(2) encrypting a quantity to obtain a second value, wherein said step (d)(2) employs said second result obtained in said step (d)(1); and
(3) replacing said first value in said log-in record with said second value.

38. The processor readable storage medium of claim 37, wherein:
said first function is a first hash function and said second function is a second hash function different than said first hash function, and
said third function is a third hash function and said fourth function is a fourth hash function different than said third hash function.

39. The processor readable storage medium of claim 37, wherein:
said first function is a first cryptographic cipher and said second function is a second cryptographic cipher different than said first cryptographic cipher, and
said third function is a third cryptographic cipher and said fourth function is a fourth cryptographic cipher different than said third cryptographic cipher.

40. The processor readable storage medium of claim 31, wherein said computer system includes a log-in record corresponding to said client, wherein said log-in record includes a first entry identifying said current security scheme, said computer implemented method further including the step of:
(e) replacing said first entry in said log-in record with a second entry identifying said desired security scheme.

41. A processor readable storage medium having processor readable code embodied on said processor readable storage medium, said processor readable code for programming a processor to perform a method for providing a client with access to a primary system through an intermediate system, said method comprising the steps of:
(a) creating a log-in record, wherein said log-in record includes a security identifier and a first encrypted value, wherein said security identifier corresponds to a current security scheme employed by said intermediate system;
(b) receiving log-in data for said client;
(c) authenticating access of said client to said intermediate system, based on data from said log-in data and data from said log-in record;
(d) obtaining authentication data to send to said primary system, wherein said authentication data includes data from a decrypted version of said first encrypted value;
(e) determining that said current security scheme is to be replaced by a desired security scheme; and
(f) modifying said log-in record, wherein said step (f) includes the steps of:
(1) updating said security identifier to correspond to said desired security scheme,
(2) employing data in said log-in data received in said step (b) to calculate a second encrypted value, and
(3) replacing said first encrypted value with said second encrypted value.

42. The processor readable storage medium of claim 41, wherein said step (c) includes the steps of:
(1) applying a first function to a value in said log-in data to obtain a first result, and
(2) comparing said first result obtained in said step (c)(1) to a first value stored in said log-in record, and
wherein said step (f) includes the steps of:
(4) applying a second function to said value in said log-in data to obtain a second result; and
(5) replacing said first value in said log-in record with said second result obtained in said step (d)(4).

43. The processor readable storage medium of claim 42, wherein said first function is a first hash function and said second function is a second hash function different than said first hash function.

44. The processor readable storage medium of claim 42, wherein said step (d) includes the steps of:
(3) applying a third function to said value in said log-in data to obtain a first credential; and
(4) decrypting said first encrypted value in said log-in record to obtain a first decrypted value, wherein said step (d)(4) employs said first credential, wherein said authentication data includes said first decrypted value, and
wherein said step (f)(2) includes the steps of:
(i) applying a fourth function to said value in said log-in record to obtain a second credential; and
(ii) encrypting a quantity to obtain said second encrypted value, wherein said step (f)(2)(ii) employs said second credential.

45. The processor readable storage medium of claim 42, wherein said step (d) includes the steps of:
(3) inputting said value in said log-in data to a first cryptographic cipher to obtain a first decryption key; and
(4) decrypting said first encrypted value in said log-in record to obtain a first decrypted value, wherein said step (d)(4) employs said first decryption key, wherein said authentication data includes said first decrypted value, and
wherein said step (f)(2) includes the steps of:
(i) inputting said value in said log-in record to a second cryptographic cipher to obtain said second encryption key;
(ii) encrypting a quantity to obtain said second encrypted value, wherein said step (f)(2)(ii) employs said second encryption key.

46. The processor readable storage medium of claim 41, wherein said step (d) includes the steps of:
(1) applying a first function to a value in said log-in data to obtain a first credential; and
(2) decrypting said first encrypted value in said log-in record to obtain a first decrypted value, wherein said step (d)(2) employs said first credential, wherein said authentication data includes said first decrypted value, and
wherein said step (f)(2) includes the steps of:
(i) applying a second function to said value in said log-in record to obtain a second credential; and
(ii) encrypting a quantity to obtain said second encrypted value, wherein said step (f)(2)(ii) employs said second credential.

47. The processor readable storage medium of claim 46, wherein said first function is a first hash function and said second function is a second hash function different than said first hash function.

48. The processor readable storage medium of claim 46, wherein said first function is a first cryptographic cipher and said second function is a second cryptographic cipher different than said first cryptographic cipher.

49. An apparatus providing a client with access to a primary system through an intermediate system, said apparatus comprising:
a processor; and
a processor readable storage medium, in communication with said processor, said processor readable storage medium storing code for programming said processor to perform a method for updating a current security scheme on a computer system, wherein said method includes the steps of:
(a) receiving log-in data for a client during a first log-in attempt;
(b) authenticating said client, wherein said step (b) includes the steps of:
(1) applying a first function to a value in said log-in data to obtain a first result, and
(2) employing said first result in determining whether to authenticate said client during said first log-in attempt;
(c) determining that said current security scheme is to be replaced by a desired security scheme; and
(d) modifying at least one record in said computer system in response to said step (c), wherein said step (d) includes the step of:
(1) applying a second function to said value received in said step (a) to obtain a second result.

50. The apparatus of claim 49, wherein said computer system maintains a log-in record, wherein said step (b)(2) includes the steps of:
(i) comparing said first result obtained in said step (b)(1) to a first value stored in said log-in record, and
wherein said step (d) includes the step of:
(2) replacing said first value in said log-in record with said second result obtained in said step (d)(1).

51. The apparatus of claim 50, wherein said step (b) includes the steps of:
(3) applying a third function to said value in said log-in data to obtain a first credential; and
(4) decrypting a third value in said log-in record to obtain a decrypted value, wherein said step (b)(4) employs said first credential, and
wherein said step (d) includes the steps of:
(3) applying a fourth function to said value in said log-in record to obtain a second credential;
(4) encrypting a quantity to obtain a fourth value, wherein said step (d)(4) employs said second credential; and
(5) replacing said third value in said log-in record with said fourth value.

52. The apparatus of claim 51, wherein:
said first function is a first hash function and said second function is a second hash function different than said first hash function, and said third function is a third hash function and said fourth function is a fourth hash function different than said third hash function.

53. The apparatus of claim 50, wherein said step (b) includes the steps of:
(3) inputting said value in said log-in data into a first cryptographic cipher to obtain a first encryption key; and
(4) decrypting a third value in said log-in record to obtain a decrypted value, wherein said step (b)(4) employs said first encryption key,
wherein said step (d) includes the steps of:
(3) inputting said value in said log-in data into a second cryptographic cipher to obtain a second encryption key;
(4) encrypting a quantity to obtain a fourth value, wherein said step (d)(4) employs said second encryption key; and
(5) replacing said third value in said log-in record with said fourth value.

54. The apparatus of claim 49, wherein said computer system maintains a log-in record, wherein said step (b)(2) includes the steps of:
(i) decrypting a first value in said log-in record to obtain a decrypted value, wherein said step (b)(2)(i) employs said first result as a decryption key; and
(ii) forwarding said decrypted value to a primary computer system, and
wherein said step (d) includes the steps of:
(2) encrypting a quantity to obtain a second value, wherein said step (d)(2) employs said second result obtained in said step (d)(1); and
(3) replacing said first value in said log-in record with said second value.

55. The apparatus of claim 54, wherein:
said first function is a first hash function and said second function is a second hash function different than said first hash function, and
said third function is a third hash function and said fourth function is a fourth hash function different than said third hash function.

56. The apparatus of claim 54, wherein:
said first function is a first cryptographic cipher and said second function is a second cryptographic cipher different than said first cryptographic cipher, and
said third function is a third cryptographic cipher and said fourth function is a fourth cryptographic cipher different than said third cryptographic cipher.

57. The apparatus of claim 49, wherein said computer system includes a log-in record corresponding to said client, wherein said log-in record includes a first entry identifying said current security scheme, said method further including the step of:
(e) replacing said first entry in said log-in record with a second entry identifying said desired security scheme.
